(19) United States
(12) Patent Application Publication
(10) Pub. No.: US 2019/0146559 A1
(43) Pub. Date: May 16, 2019

(54) TORSION DEVICE AND ELECTRONIC APPARATUS

(71) Applicant: FOSITEK CORPORATION, New Taipei City (TW)

(72) Inventors: I-HUNG CHIANG, NEW TAIPEI CITY (TW); AN-SZU HSU, NEW TAIPEI CITY (TW)

(21) Appl. No.: 16/154,809

(22) Filed: Oct. 9, 2018

(30) Foreign Application Priority Data
Nov. 13, 2017 (TW) 106216841

(51) Int. Cl. G06F 1/16

(52) U.S. Cl. CPC G06F 1/1681; E05D 11/082; G06F 1/1616

(57) ABSTRACT

A torsion device is adjustable for providing a predetermined torsion curve, and includes two external connecting members and N numbers of torsion modules, in which 2≤N. Each torsion module includes a plurality of stacked torsion washers, an interlocking unit, and two shafts passing through the torsion washers and the interlocking unit. The two shafts of each torsion module are rotatable relative to each other in an angle range so as to generate a torsion curve, the N numbers of the torsion modules generate M kinds of torsion curves different from each other, and 2≤M≤N. The predetermined torsion curve is formed by adding at least two of the M kinds of the torsion curves, and at least two of the N numbers of the torsion modules corresponding to the predetermined torsion curve are fixed to the two external connecting members.

### CROSS-REFERENCE TO RELATED PATENT APPLICATION

This application claims the benefit of priority to Taiwan Patent Application No. 106216841, filed on Nov. 13, 2017. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### BACKGROUND OF THE INVENTION

### 1. Field of the Invention

The present disclosure relates to a torsion device; in particular, to a torsion device and an electronic apparatus each having at least two torsion modules of different torsion curves for meeting different torsion demands.

### 2. Description of Related Art

A conventional torsion device is formed by assembling a plurality of identical torsion modules, so that the torsion curve of the conventional torsion device is determined only by a single kind of torsion module. In other words, the conventional torsion device with a single kind of torsion module cannot have a different torsion curve. Thus, the conventional torsion device cannot achieve different torsion demands, which restricts the development of relevant technological fields.

### SUMMARY OF THE INVENTION

The present disclosure provides a torsion device and an electronic apparatus to solve the drawbacks associated with conventional torsion devices.

The present disclosure provides an electronic apparatus, which includes a torsion device, a first electronic device, and a second electronic device. The torsion device includes two external connecting members arranged separate from each other, a first torsion module, and a second module. The first torsion module includes a plurality of stacked first torsion washers, a first interlocking unit, and two first shafts passing through the first torsion washers and the first interlocking unit. The two first shafts are respectively fixed to the two external connecting members. The second module includes a plurality of stacked second torsion washers, a second interlocking unit, and two second shafts passing through the second torsion washers and the second interlocking unit. The two second shafts are respectively fixed to the two external connecting members. Moreover, central axes of the two first shafts respectively overlap with that of the two second shafts, and wherein when the two external connecting members are rotated relative to each other in an angle range, a first torsion curve generated from the first torsion module is different from a second torsion curve generated from the second torsion module. The first electronic device and the second electronic device are respectively fixed to the two external connecting members.

The present disclosure also provides a torsion device having a torsion-adjusting function for providing a predetermined torsion curve. The torsion device includes two external connecting members arranged separate from each other and N numbers of torsion modules. The N numbers of torsion modules each include a plurality of stacked torsion washers, an interlocking unit, and two shafts passing through the torsion washers and the interlocking unit. N is a positive integer equal to or larger than two. The two shafts of each of the N numbers of the torsion modules are rotatable relative to each other in an angle range so as to generate a torsion curve, and the N numbers of the torsion modules generate M kinds of torsion curves different from each other. Moreover, M is a positive integer equal to or larger than two and equal to or less than N. The predetermined torsion curve is formed by adding at least two of the M kinds of the torsion curves, and the two shafts of each of at least two of the N numbers of the torsion modules (the at least two of the N numbers of the torsion modules correspond to the predetermined torsion curve) are adapted to be respectively fixed to the two external connecting members.

In summary, the torsion device (or the electronic apparatus) of the present disclosure can provide a torsion curve, which cannot be provided by a single kind of torsion module, by choosing a suitable combination (e.g., the combination of the first torsion module and the second torsion module) from the torsion modules to add at least two different torsion curves, thereby meeting different torsion demands. Moreover, since each of the chosen torsion modules (e.g., the first torsion module and the second torsion module) in the present disclosure are in a pre-assembled state, the manufacturing process of the torsion device can be simplified for effectively reducing manufacturing costs.

In order to further appreciate the characteristics and technical contents of the present disclosure, references are hereunder made to the detailed descriptions and appended drawings in connection with the present disclosure. However, the appended drawings are merely shown for exemplary purposes, and should not be construed as restricting the scope of the present disclosure.

### BRIEF DESCRIPTION OF THE DRAWINGS

FIG. 1 is a perspective view showing an electronic apparatus according to the present disclosure;

FIG. 2 is an exploded view of a torsion device according to the present disclosure;

FIG. 3 is an exploded view of a first torsion module according to the present disclosure;

FIG. 4 is a planar view showing a first torsion washer of FIG. 3;

FIG. 5 is a planar view showing a first position of the torsion device of FIG. 3;

FIG. 6 is a planar view showing a transitional position of the torsion device of FIG. 3;

FIG. 7 is a planar view showing a second position of the torsion device of FIG. 3;

FIG. 8 is a torsion curve diagram of the first torsion module and a second torsion module;

FIG. 9 is an exploded view of the second torsion module according to the present disclosure;

FIG. 10 is a planar view of the second torsion module;

FIG. 11 is an exploded view of a third torsion module according to the present disclosure; and

FIG. 12 is a planar view of the third torsion module.

### DETAILED DESCRIPTION OF THE PREFERRED EMBODIMENTS

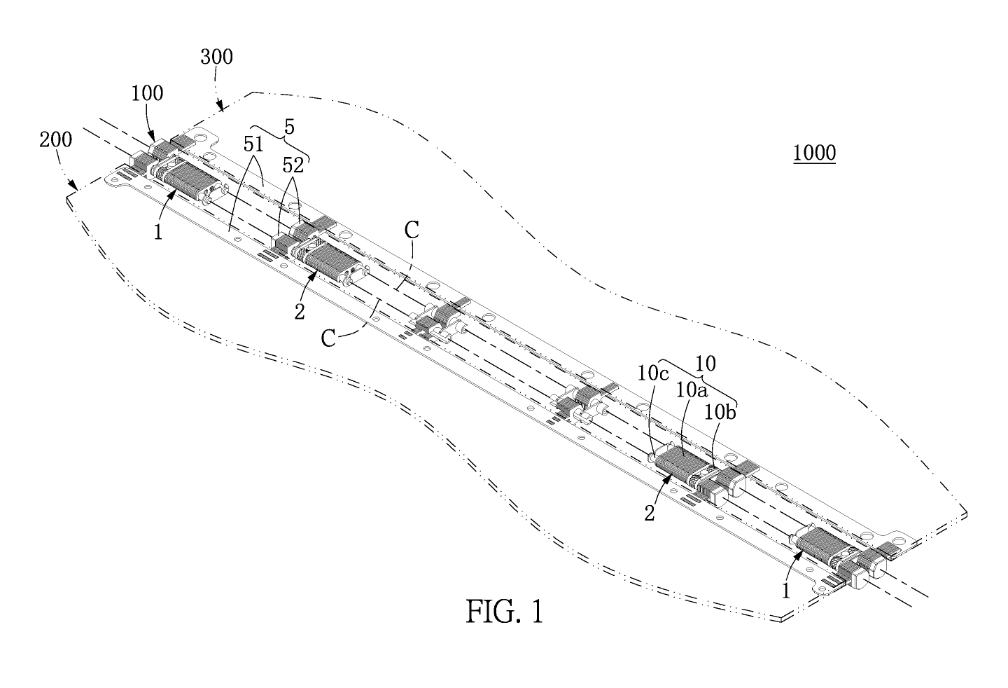

Reference is made to FIGS. 1 to 12, which illustrate an embodiment of the present disclosure. References are hereunder made to the detailed descriptions and appended drawings in connection with the present disclosure. However, the appended drawings are merely provided for exemplary purposes, and should not be construed as restricting the scope of the present disclosure.

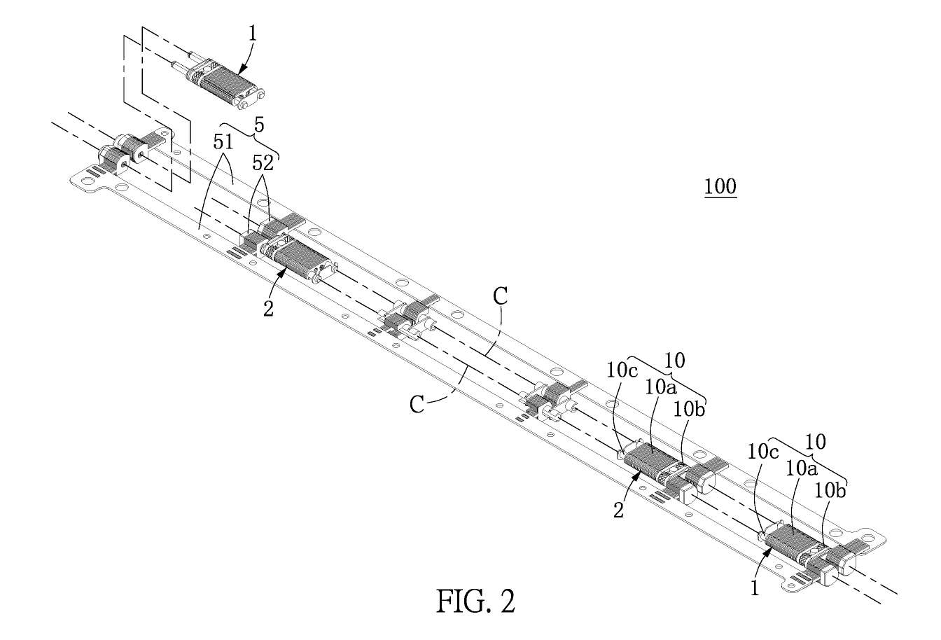

As shown in FIGS. 1 and 2, the present embodiment discloses an electronic apparatus 1000 including a torsion device 100, a first electronic device 200, and a second electronic device 300, the latter two of which are respectively fastened to two opposite sides of the torsion device 100. The torsion device 100 in the present embodiment has a torsion-adjusting function for providing a predetermined torsion curve to the first electronic device 200 and the second electronic device 300. In the present embodiment, the first electronic device 200 is a keyboard, and the second electronic device 300 is a display, but the present disclosure is not limited thereto.

Specifically, the torsion device 100 includes two external connecting members 5 arranged separate from each other and N numbers of torsion modules 10 each selectively fastened to the two external connecting members 5, and N is a positive integer equal to or larger than two (i.e., 2≤N). Each of the N numbers of the torsion modules 10 includes a plurality of stacked torsion washers 10a, an interlocking unit 10b, and two shafts 10c passing through the torsion washers 10a and the interlocking unit 10b. If at least two of the N numbers of the torsion modules 10 are fastened to the two external connecting members 5, central axes C of the two shafts 10c of one of the at least two of the N numbers of the torsion modules 10 would respectively overlap with central axes C of the two shafts 10c of another one of the at least two of the N numbers of the torsion modules 10.

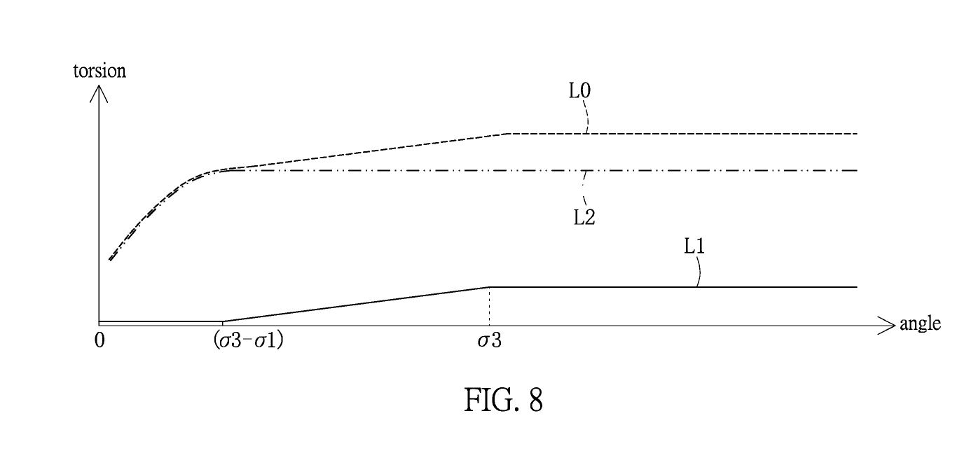

Moreover, the two shafts 10c of each of the N numbers of the torsion modules 10 are rotatable relative to each other in an angle range (e.g., 180 degrees or 360 degrees) so as to generate a torsion curve (as shown in FIG. 8), the N numbers of the torsion modules 10 can generate M kinds of torsion curves different from each other, and M is a positive integer equal to or larger than two and equal to or less than N (i.e., 2≤M≤N). The predetermined torsion curve required by the first electronic device 200 and the second electronic device 200 can be formed by adding at least two of the M kinds of the torsion curves, and the two shafts 10c of each of at least two of the N numbers of the torsion modules 10 (the at least two of the N numbers of the torsion modules 10 correspond to the predetermined torsion curve) are adapted to be respectively fixed to the two external connecting members 5.

Each of the two external connecting members 5 includes a connecting strip 51 and a plurality of rotating arms 52 fastened to the connecting strip 51. The rotating arms 52 of one of the two external connecting members 5 respectively face those of the other external connecting member 5. The connecting strips 51 of the two external connecting members 5 are respectively fixed to the first electronic device 200 and the second electronic device 300, and two of the rotating arms 52 respectively disposed on the two external members 5 and facing each other are respectively fastened to the two shafts 10c of one of the at least two of the N numbers of the torsion modules 10.

In summary, the torsion device 100 of the present embodiment can provide a torsion curve, which cannot be provided by a single kind of torsion module, by choosing a suitable combination from the N numbers of the torsion modules 10 to add at least two different torsion curves, thereby meeting different torsion demands. For example, a touch-control screen of a notebook PC (not shown) can be raised from a closed position by using a lower torsion, but when the touch-control screen and the keyboard of the notebook PC have an angle within a range of 85˜110 degrees, the touch-control screen would need to receive a higher torsion for activation of its touch-control function. In addition, since each of the torsion modules 10 in the present embodiment are pre-assembled modules, manufacture process of the torsion device 100 can be simplified for effectively reducing manufacturing costs.

The different components illustrated for the torsion device 100 are not meant to provide architectural limitations to the manner in which different embodiments may be implemented.

As shown in FIG. 2, the torsion device 100 includes two first torsion modules 1 and two second torsion modules 2, i.e., N is four and M is two. As the two first torsion modules 1 are of the same structure and the two second torsion modules 2 are of the same structure, the following description discloses the structure of just one of the two first torsion modules 1 and the structure of just one of the two second torsion modules 2 for the sake of brevity. In other words, N can be two and M can be two, but the present disclosure is not limited thereto.

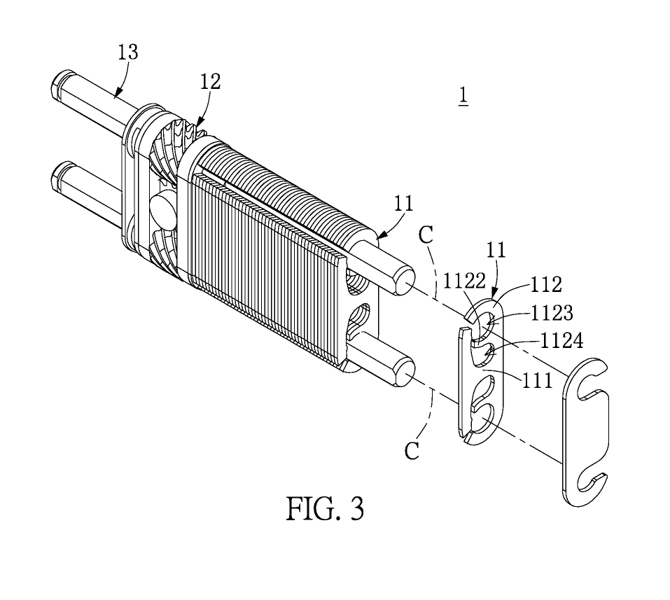

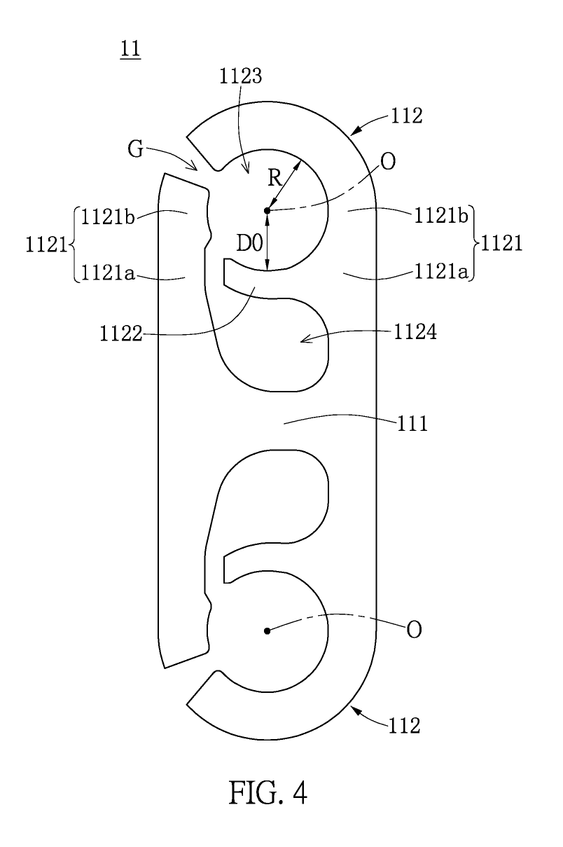

As shown in FIGS. 3 and 4, the first torsion module 1 includes a plurality of first torsion washers 11 stacked in a row, a first interlocking unit 12, and two first shafts 13 passing through the stacked first torsion washers 11 and the first interlocking unit 12. The outer edges of the first torsion washers 11 are flush with each other, and the two first shafts 13 are respectively fixed to the corresponding rotating arms 52 of the two external connecting members 5.

Specifically, each of the first torsion washers 11 has a first base portion 111 and two first elastic units 112 respectively extending from two opposite sides of the first base portion 111. The two first elastic units 112 of each of the first torsion washers 11 in the present embodiment are symmetrical to the corresponding first base portion 111. That is to say, each of the first torsion washers 11 in the present embodiment is mirror symmetrical to the first base portion 111 thereof, but the present disclosure is not limited thereto. For example, in other embodiments of the present disclosure, each of the first torsion washers 11 can be 2-fold symmetrical to the first base portion 111 thereof. In addition, the two first shafts 13 respectively pass through the two elastic units 112 of each of the torsion washers 11 in a coupling manner.

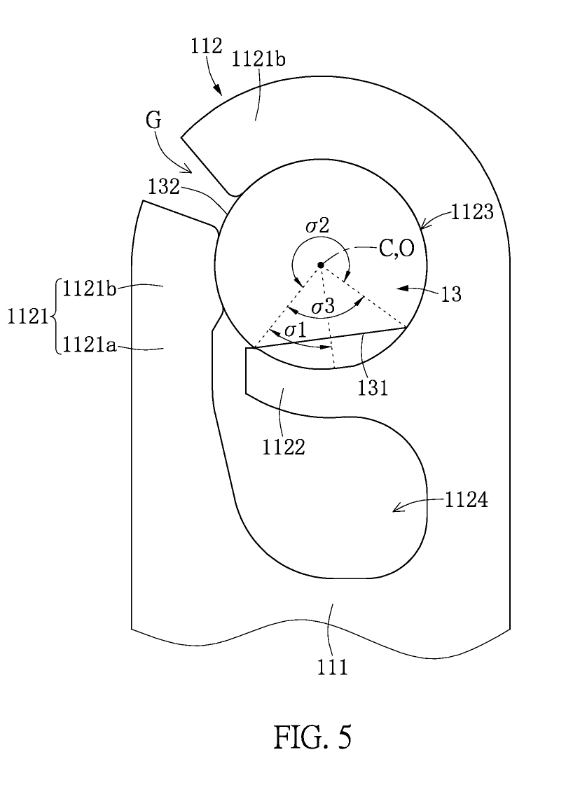

It should be noted that as the first torsion washers 11 in the present embodiment are of the same structure, each of the first torsion washers 11 is symmetrical to the first base portion 111 thereof, and the two first shafts 13 are the same or symmetrical in structure. The following description discloses only the structure of the first base portion 111 and one of the first elastic units 112 of one of the first torsion washers 11 and the structure of the corresponding first shaft 13 for the sake of brevity (as shown in FIG. 5).

As shown in FIGS. 4 and 5, the first elastic arm 112 includes two first external elastic arms 1121 and a torsion-adjusting arm 1122. The two first external elastic arms 1121 in the present embodiment have different lengths, one end of the two first external elastic arms 1121 is connected to the first base portion 111, and the other end of the two first external elastic arms 1121 (i.e., the free end of the first external elastic arms 1121 as shown in FIG. 4) has a gap G therebetween. Specifically, each of the first external elastic arms 1121 has an extending segment 1121a perpendicularly extending from the first base portion 111 and an abutting segment 1121b extending from the extending segment 1121a. The two extending segments 1121a are respectively connected to two opposite portions of the top edge of the first base portion 111.

The torsion-adjusting arm 1122 is arranged inside of the two external elastic arms 1121, and the torsion-adjusting arm 1122 in the present embodiment is substantially and perpendicularly connected to the inner edge of the longer external elastic arm 1121. The torsion-adjusting arm 1122 extends from a junction portion of the extending segment 1121a and the abutting segment 1121b of the longer external elastic arm 1121 toward a junction portion of the extending segment 1121a and the abutting segment 1121b of the shorter external elastic arm 1121.

A space surrounded by the first base portion 111 and the two first external elastic arms 1121 is divided by the torsion-adjusting arm 1122 into a first hole 1123 and a first slot 1124 in air communication with the first hole 1123. The first hole 1123 and the first slot 1124 are respectively located at two opposite sides of the torsion-adjusting arm 1122. The abutting segments 1121b of the two first external elastic arms 1121 and the torsion-adjusting arm 1122 surroundingly co-define the first hole 1123. The extending segments 1121a of the two first external elastic arms 1121, the torsion-adjusting arm 1122, and the first base portion 111 surroundingly co-define the first slot 1124.

Specifically, since an inner edge of the abutting segment 1121b of each of the two first external elastic arms 1121 is substantially in an arc shape, and an inner edge of the torsion-adjusting arm 1122 is also substantially in an arc shape, the first hole 1123 is substantially in a circle shape and has a center O. A distance between the center O and each of the first external elastic arms 1121 is defined as a radius R. A distance between the center O and the torsion-adjusting arm 1122 is defined as an interference distance D0 and is smaller than the radius R. The interference distance D0 is preferably 90˜98% of the radius R, but the present disclosure is not limited thereto. Moreover, as shown in FIG. 5, the torsion-adjusting arm 1122 has a first central angle corresponding to the center O of the first hole 1123, and the first central angle has σ1 degrees. The gap G has a central angle corresponding to the center O, and the central angle of the gap G is preferably smaller than or equal to 30 degrees.

As shown in FIGS. 4 to 6, the first shaft 13 defines a central axis C, and an outer surface of the first shaft 13 has a non-contact surface 131 and an arc-shaped contact surface 132. A distance D1 between the contact surface 132 and the central axis C is substantially equal to the radius R, and a distance D2 between the non-contact surface 131 and the central axis C is smaller than the interference distance D0. The non-contact surface 131 in the present embodiment is a flat surface parallel to the central axis C and formed by cutting the first shaft 13, but the present disclosure is not limited thereto.

The contact surface 132 has a second central angle corresponding to the central axis C, and the second central angle has σ2 degrees. The non-contact surface 131 has a third central angle corresponding to the central axis C, and the third central angle has σ3 degrees. Moreover, σ2+σ3=360. In the present embodiment, the second central angle of the contact surface 132 is preferably larger than the third central angle of the non-contact surface 131 (i.e., σ3<σ2), but the present disclosure is not limited thereto.

The first shaft 13 couples through the first hole 1123 of the first elastic unit 112 of each of the first torsion washers 11, and the central axis C of the first shaft 13 in the present embodiment preferably overlaps with the centers O of the first torsion washers 11, thus, the contact surface 132 of the first shaft 13 contacts with the first external elastic arms 1121 of each of the first torsion washers 11 and selectively contacts with the torsion-adjusting arm 1122 of each of the first torsion washers 11. It should be noted that the first central angle of the torsion-adjusting arm 1122 is smaller than the second central angle of the contact surface 132 of the first shaft 13 (i.e., σ1<σ2), and the first central angle of the torsion-adjusting arm 1122 is also smaller than the third central angle of the non-contact surface 131 of the first shaft 13 (i.e., σ1<σ3).

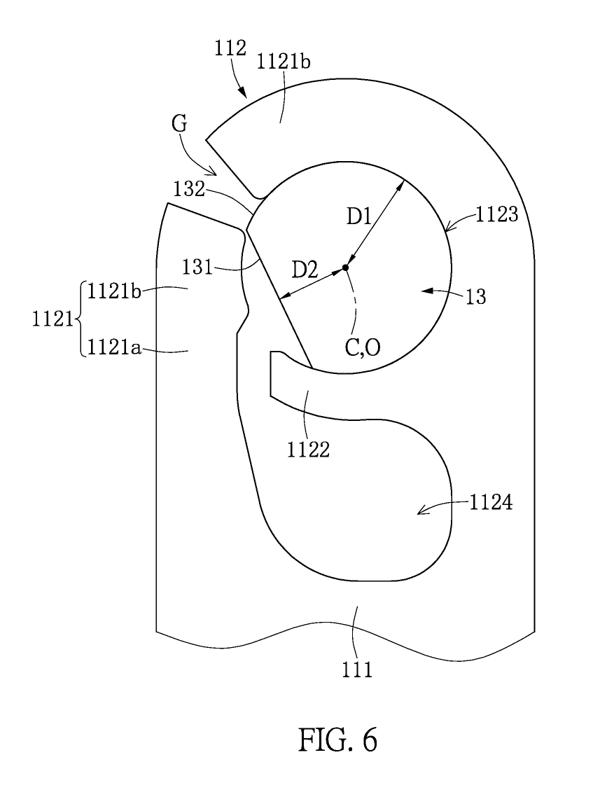

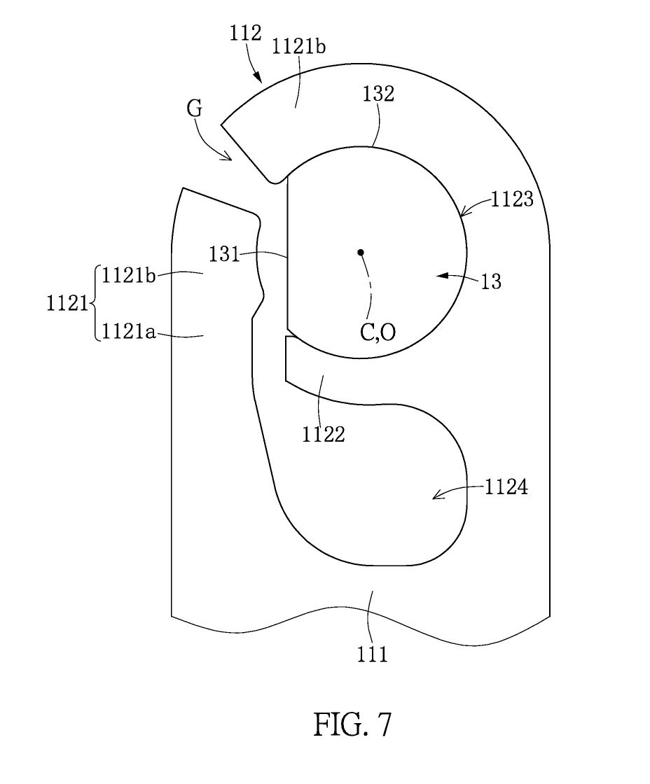

When the two external connecting members 5 are rotated relative to each other in an angle range, the first torsion module 1 generates a first torsion curve L1 (as shown in FIG. 8). Specifically, one of the first shafts 13 is rotatable relative to the first torsion washers 11 along the central axis C from a first position (as shown in FIG. 5) to a second position (as shown in FIG. 7) via a transitional position (as shown in FIG. 6), and drives the other first shaft 13 at the same time through the first interlocking unit 12. That is to say, the rotating direction of the first shaft 13 is exemplified as a clockwise direction as shown in FIGS. 5 to 7.

As shown in FIGS. 5 and 8, when the first shaft 13 is in the first position, the torsion-adjusting arm 1122 of each of the first torsion washers 11 does not contact the first shaft 13 (i.e., each torsion-adjusting arm 1122 faces the non-contact surface 131), and each of the first torsion washers 11 generates a first torsion (i.e., a front segment of the first torsion curve L1 as shown in FIG. 8) by friction between the contact surface 132 and the first external elastic arms 1121. As shown in FIGS. 6 and 8, when the first shaft 13 is in the transitional position, the torsion-adjusting arm 1122 of each of the first torsion washers 11 partially contacts the contact surface 132 of the first shaft 13, and each of the first torsion washers 11 generates a gradually increasing torsion (i.e., a middle segment of the first torsion curve L1 as shown in FIG. 8) by friction from the contact surface 132 rubbing against the first external elastic arms 1121 and a part of the torsion-adjusting arm 1122. As shown in FIGS. 7 and 8, when the first shaft 13 is in the second position, the torsion-adjusting arm 1122 of each of the first torsion washers 11 entirely contacts the contact surface 132 of the first shaft 13, and each of the first torsion washers 11 generates a second torsion (i.e., a rear segment of the first torsion curve L1 as shown in FIG. 8) by friction from the contact surface 132 rubbing against the first external elastic arms 1121 and the torsion-adjusting arm 1122. Moreover, the second torsion is larger than the first torsion, and the gradually increasing torsion has a range that gradually increases from the first torsion to the second torsion.

In other words, for the first shaft 13 and the corresponding first elastic unit 112 of each of the first torsion washers 11, when the first shaft 13 is in the first position (as shown in FIG. 5), a part of the non-contact surface 131 (i.e., the left part of the non-contact surface 131 as shown in FIG. 5) faces the torsion-adjusting arm 1122, and the other part of the non-contact surface 131 (i.e. the right part of the non-contact surface 131 as shown in FIG. 5) has a central angle corresponding to the central axis C and having σ3-σ1 degrees. When the first shaft 13 is in the transitional position (as shown in FIG. 6), the first shaft 13 is rotated from the first position until rotating an angle within a range of σ3-σ1 degrees to σ3 degrees. When the first shaft 13 is in the second position (as shown in FIG. 7), the first shaft 13 is rotated from the first position until rotating an angle more than σ3 degrees.

In summary, the first torsion module 1 of the present disclosure adapts the first external elastic arms 1121 and the torsion-adjusting arm 1122 of each of the first torsion washers 11 to cooperate with the corresponding first shaft 12, so that the first torsion module 1 can provide torsions of different values as the first shaft 13 moves to different positions with respect to the first torsion washers 11. Moreover, since the torsion-adjusting arm 1122 of each of the first torsion washers 11 provides a torsion by cooperating with the first shaft 13 in an interference fit, the torsion-adjusting arm 1122 of each of the first torsion washers 11 is easily deformed. Thus, each of the first torsion washers 11 is formed with the first slot 1124 to receive a lubricating oil for reducing the friction between the torsion-adjusting arm 1122 of each of the first torsion washers 11 and the first shaft 13, thereby providing a stable torsion in different values.

As shown in FIG. 8, since the first torsion curve L1 generated from the first torsion module 1 cannot achieve the predetermined torsion curve L0, the torsion device 100 of the present embodiment further combines the first torsion module 1 with the second torsion module 2 having a second torsion curve L2 different from the first torsion curve L1, so as to achieve the predetermined torsion curve LO by adding the first torsion curve L1 and the second torsion curve L2. The following description discloses the structure of each component of the second torsion module 2.

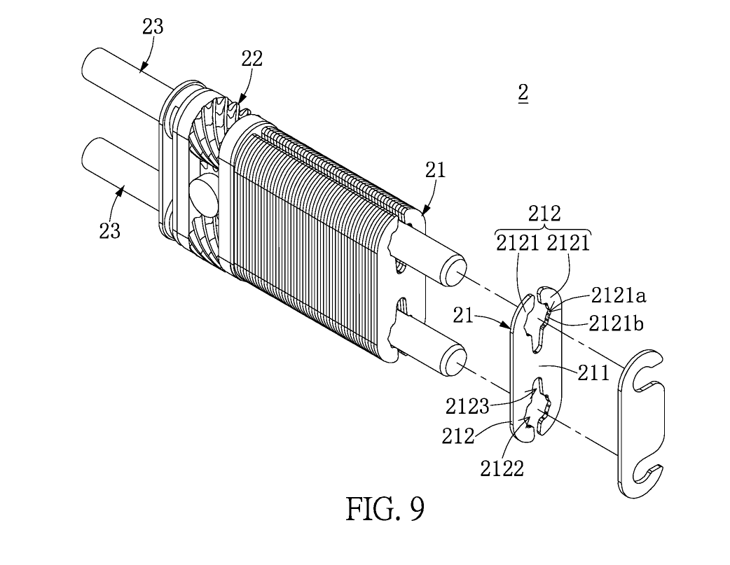

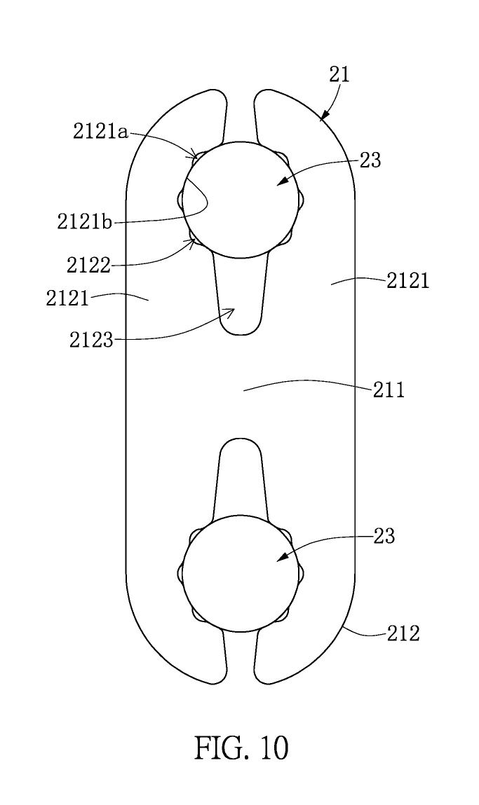

As shown in FIGS. 9 and 10, the second torsion module 2 includes a plurality of second torsion washers 21 stacked in a row, a second interlocking unit 22, and two second shafts 23 passing through the stacked second torsion washers 21 and the second interlocking unit 22. The outer edges of the second torsion washers 21 are flush with each other, and the two second shafts 23 are respectively fixed to the corresponding rotating arms 52 of the two external connecting members 5.

Each of the second torsion washers 21 includes a second base portion 211 and two second elastic units 212 respectively extending from two opposite sides of the second base portion 211. Each of the second elastic units 212 includes two second external elastic arms 2121. For the second base portion 211 and each of the two second elastic units 212 of each of the second torsion washers 21, a space surrounded by the second base portion 211 and the two second external elastic arms 2121 is divided into a second hole 2122 and a second slot 2123 in air communication with the second hole 2122, and an inner side of each of the second external elastic arms 2121 defining a part of the first hole 2122 includes a plurality of troughs 2121a and a plurality of friction segments 2121b staggeredly arranged with the troughs 2121a.

Moreover, the two second shafts 23 respectively pass through the two second holes 2122 of each of the second torsion washers 21, central axes of the two second shafts 23 respectively overlap with that of the two first shafts 13, and each of the two second shafts 23 abuts against the friction segments 2121b of the two corresponding second external elastic arms 2121 of each of the second torsion washers 21. Thus, when the two external connecting members 5 are rotated relative to each other in the angle range, the second torsion module 2 can generate a second torsion curve L2 different from the first torsion curve L1. In the present embodiment, at any angle in the angle range, a torsion generated from the second torsion module 2 is preferably different from a torsion generated from the first torsion module 1.

In summary, the torsion device 100 of the present embodiment can provide the predetermined torsion curve L0, which cannot be provided by a single kind of torsion module, by assembling the first torsion module 1 and the second torsion module 2 to add the first torsion curve L1 and the second torsion curve L2, thereby allowing the torsion device 100 to be quickly assembled to achieve design requirements.

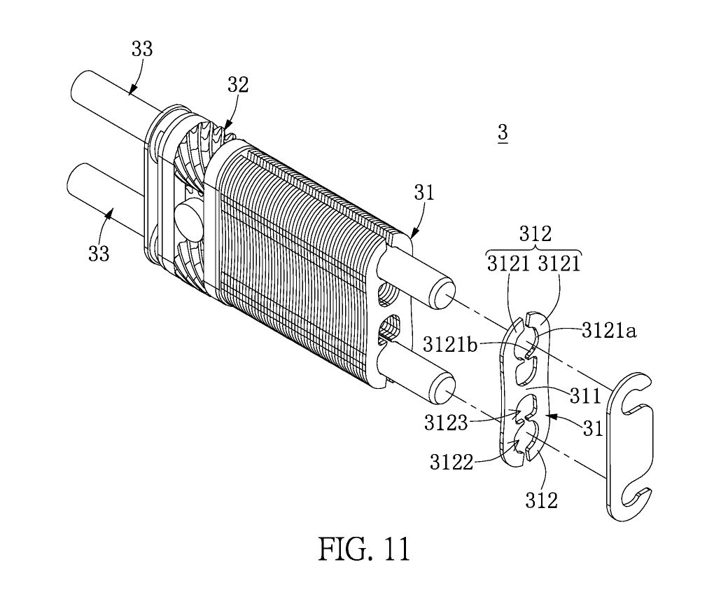

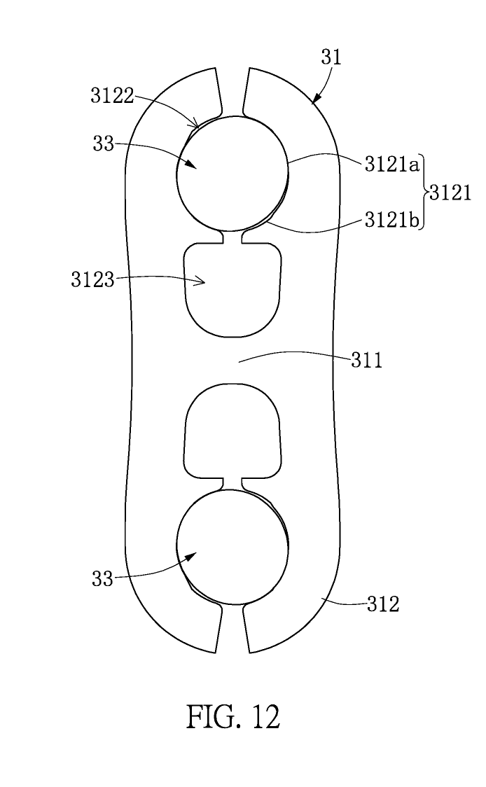

Reference is made to FIGS. 11 and 12, which illustrate another embodiment of the present disclosure. The torsion device 100 of the present embodiment includes two first torsion modules 1, a second torsion module 2, and a third torsion module 3, i.e.,, N is four and M is three, but the present disclosure is not limited thereto. In other embodiments of the present disclosure, the torsion device 100 can include at least two torsion modules 10 selected from the first torsion module 1, the second torsion module 2, and the third torsion module 3.

It should be noted that the first torsion module 1 and the torsion module 2 have been disclosed in the above description, and the following description discloses the structure just of each component of the third torsion module 3.

As shown in FIGS. 11 and 12, the third torsion module 3 includes a plurality of third torsion washers 31 stacked in a row, a third interlocking unit 32, and two third shafts 33 passing through the stacked third torsion washers 31 and the third interlocking unit 32. The outer edges of the third torsion washers 31 are flush with each other, and the two third shafts 33 are respectively fixed to the corresponding rotating arms 52 of the two external connecting members 5. Specifically, each of the third torsion washers 31 includes a third base portion 311 and two third elastic units 312 respectively extending from two opposite sides of the third base portion 311. Each of the third elastic units 312 includes two third external elastic arms 3121. For the third base portion 311 and each of the two third elastic units 312 of each of the third torsion washers 31, a space surrounded by the third base portion 311 and the two third external elastic arms 3121 is divided into a third hole 3122 and a third slot 3123 in air communication with the third hole 3122, and an inner side of each of the third external elastic arms 3121 defining a part of the third hole 3122 includes an arced segment 3121a and an escaping segment 3121b connected to the arced segment 3121a.

Moreover, the two third shafts 33 respectively couple through the third second holes 3122 of each of the third torsion washers 31, central axes of the two third shafts 33 respectively overlap with that of the two first shafts 13, each of the two third shafts 33 abuts against the arced segments 3121a of the two corresponding third external elastic arms 3121 of each of the third torsion washers 31, and each of the two third shafts 33 does not contact the escaping segments 3121b of the two corresponding third external elastic arms 3121 of each of the third torsion washers 31. Thus, when the two external connecting members 5 are rotated relative to each other in the angle range, the third torsion module 3 can generate a third torsion curve (not shown) different from each of the first torsion curve L1 and the second torsion curve L2.

In summary, the torsion device 100 of the present embodiment can provide a torsion curve, which cannot be provided by a single kind of torsion module, by assembling the first torsion module 1, the second torsion module 2, and the third torsion module 3 to add the first torsion curve L1, the second torsion curve L2, and the third torsion curve, thereby allowing the torsion device 100 to be quickly assembled to achieve design requirements.

The descriptions illustrated supra set forth simply the preferred embodiments of the present disclosure; however, the characteristics of the present disclosure are by no means restricted thereto. All changes, alterations, or modifications conveniently considered by those skilled in the art are deemed to be encompassed within the scope of the present disclosure delineated by the following claims.

What is claimed is:

1. An electronic apparatus, comprising:
a torsion device, including:
two external connecting members arranged separate from each other;
a first torsion module including a plurality of stacked first torsion washers, a first interlocking unit, and two first shafts passing through the first torsion washers and the first interlocking unit, wherein the two first shafts are respectively fixed to the two external connecting members; and
a second module including a plurality of stacked second torsion washers, a second interlocking unit, and two second shafts passing through the second torsion washers and the second interlocking unit, wherein the two second shafts are respectively fixed to the two external connecting members;
wherein central axes of the two first shafts respectively overlap with that of the two second shafts, and wherein when the two external connecting members are rotated relative to each other in an angle range, a first torsion curve generated from the first torsion module is different from a second torsion curve generated from the second torsion module; and
a first electronic device and a second electronic device respectively fixed to the two external connecting members.

2. The electronic apparatus as claimed in claim 1, wherein at any angle of the angle range, a torsion generated from the first torsion module is different from a torsion generated from the second torsion module.

3. The electronic apparatus as claimed in claim 1, wherein each of the first torsion washers includes a first base portion and two first elastic units respectively extending from two opposite sides of the first base portion, and each of the first elastic units includes two first external elastic arms and a torsion-adjusting arm arranged inside the two first external elastic arms, wherein for the first base portion and each of the two first elastic units of each of the first torsion washers, a space surrounded by the first base portion and the two first external elastic arms is divided by the torsion-adjusting arm into a first hole and a first slot in air communication with the first hole, a distance between a center of the first hole and any one of the two first external elastic arms is defined as a radius, and a distance between the center of the first hole and the torsion-adjusting arm is defined as an interference distance and is smaller than the radius, wherein the two first shafts respectively pass through the two first holes of each of the first torsion washers, an outer surface of each of the two shafts has a non-contact surface and a contact surface, and wherein for each of the two first shafts, a distance between the contact surface and the central axis is substantially equal to the radius, and a distance between the non-contact surface and the central axis is less than the interference distance.

4. The electronic apparatus as claimed in claim 3, wherein the two first elastic units of each of the first torsion washers are symmetrical to the corresponding base portion; for the first base portion and each of the first elastic units of each of the first torsion washers, the torsion-adjusting arm has a first central angle corresponding to the center of the first hole and having al degrees; for each of the two first shafts, the contact surface has a second central angle corresponding to the central axis and having σ2 degrees, and the non-contact surface has a third central angle corresponding to the central axis and having σ3 degrees, and wherein σ2+σ3=360, σ1<σ2, and σ1<σ3.

5. The electronic apparatus as claimed in claim 1, wherein each of the second torsion washers includes a second base portion and two second elastic units respectively extending from two opposite sides of the second base portion, and each of the second elastic units includes two second external elastic arms, wherein for the second base portion and each of the two second elastic units of each of the second torsion washers, a space surrounded by the second base portion and the two second external elastic arms is divided into a second hole and a second slot in air communication with the second hole, and an inner side of each of the second external elastic arms defining a part of the first hole includes a plurality of troughs and a plurality of friction segments staggeredly arranged with the troughs, and wherein the two second shafts respectively pass through the two second holes of each of the second torsion washers, and each of the two second shafts abuts against the friction segments of the two corresponding second external elastic arms of each of the second torsion washers.

6. The electronic apparatus as claimed in claim 1, further comprising a third module including a plurality of stacked third torsion washers, a third interlocking unit, and two third shafts passing through the third torsion washers and the third interlocking unit, wherein central axes of the two third shafts respectively overlap with the central axes of the two first shafts, and the two third shafts are respectively fixed to the two external connecting members, and wherein when the two external connecting members are rotated relative to each other in the angle range, a third torsion curve generated from the third torsion module is different from each of the first torsion curve and the second torsion curve.

7. The electronic apparatus as claimed in claim 6, wherein each of the third torsion washers includes a third base portion and two third elastic units respectively extending from two opposite sides of the third base portion, and each of third first elastic units includes two third external elastic arms, wherein for the third base portion and each of the two third elastic units of each of the third torsion washers, a space surrounded by the third base portion and the two third external elastic arms is divided into a third hole and a third slot in air communication with the third hole, and an inner side of each of the third external elastic arms defining a part of the third hole includes an arced segment and an escaping segment connected to the arced segment, and wherein the two third shafts respectively couple through the two third holes of each of the third torsion washers, and each of the two third shafts abuts against the arced segments of the two corresponding third external elastic arms of each of the third torsion washers.

8. A torsion device having a torsion-adjusting function for providing a predetermined torsion curve, comprising:
two external connecting members arranged separate from each other; and
N numbers of torsion modules each including a plurality of stacked torsion washers, an interlocking unit, and two shafts passing through the torsion washers and the interlocking unit, wherein N is a positive integer equal to or larger than two,
wherein the two shafts of each of the N numbers of the torsion modules are rotatable relative to each other in an angle range so as to generate a torsion curve, the N numbers of the torsion modules generate M kinds of torsion curves different from each other, and M is a positive integer equal to or larger than two and equal to or less than N, and
wherein the predetermined torsion curve is formed by adding at least two of the M kinds of the torsion curves, and the two shafts of each of at least two of the N numbers of the torsion modules corresponding to the predetermined torsion curve are respectively fixed to the two external connecting members.

9. The torsion device as claimed in claim 8, wherein each of the two external connecting members includes a connecting strip and a plurality of rotating arms fastened to the connecting strip, the rotating arms of one of the two external connecting members respectively face those of the other external connecting member, and two of the rotating arms respectively disposed on the two external members and facing each other are respectively fastened to the two shafts of one of the at least two of the N numbers of the torsion modules.

10. The torsion device as claimed in claim 8, wherein central axes of the two shafts of one of the at least two of the N numbers of the torsion modules respectively overlap with central axes of the two shafts of another one of the at least two of the N numbers of the torsion modules.
